(19) United States
(12) Patent Application Publication
(10) Pub. No.: US 2007/0032396 A1
(43) Pub. Date: Feb. 8, 2007

(54) Peroxycarboxylic acid-based capsules having a long shelf life

(76) Inventors: Peter Schmiedel, Duesseldorf (DE); Heribert Kaiser, Duesseldorf (DE); Elke Scholl, Dusseldorf (DE); Wolfgang von Rybinski, Duesseldorf (DE)

Correspondence Address: PAUL & PAUL, 2000 MARKET STREET, PHILADELPHIA, PA, 19103-3229, US

(21) Appl. No.: 11/299,166

(22) Filed: Dec. 9, 2005

Related U.S. Application Data
(63) Continuation of application No. PCT/EP04/06168, filed on Jun. 8, 2004.

(30) Foreign Application Priority Data
Jun. 13, 2003 (DE) DE 103 27 127.9
Dec. 22, 2003 (DE) DE 103 61 100.2

(51) Int. Cl. C11D 3/395

(52) U.S. Cl. 510/302

(57) ABSTRACT

A method for producing multilayer capsules that are loaded with organic percarboxylic acids, particularly imido-percarboxylic acids (e.g., 6-phthalimido-peroxy-caproic acid), and comprise a shell which is based on at least one inorganic salt, and the use of the capsules produced according to said method in detergents and cleaners, especially liquid detergents and cleaners, especially liquid detergents and cleaners, dental care products, hair dyes, and decolorants or bleaching agents for technical applications.

### CROSS-REFERENCE TO RELATED APPLICATIONS

This application is a continuation under 35 U.S.C. § 365(c) and 35 U.S.C. § 120 of international application PCT/EP2004/006168, filed Jun. 8, 2004. This application also claims priority under 35 U.S.C. § 119 of DE 103 27 127.9, filed Jun. 13, 2003, and of DE 103 61 100.2, filed Dec. 22, 2003, each of which is incorporated herein by reference in its entirety.

### STATEMENT REGARDING FEDERALLY SPONSORED RESEARCH OR DEVELOPMENT

Not Applicable

### INCORPORATION-BY-REFERENCE OF MATERIALS SUBMITTED ON A COMPACT DISC

Not Applicable

### BACKGROUND OF THE INVENTION

(1) Field of the Invention

The present invention relates to a process for producing capsules laden with at least one organic peroxycarboxylic acid which have a capsule coating based on at least one inorganic salt and a capsule core based on at least one organic peroxycarboxylic acid, and also to the capsules produced in this way themselves. The present invention further relates to the use of these capsules as a bleach or bleach component, especially for use thereof in laundry detergents and cleaning compositions, especially in liquid laundry detergents and cleaning compositions, dental care compositions, hair dyeing compositions and decolorizing or bleaching compositions for industrial applications, and also to the products themselves comprising these capsules, i.e. laundry detergents and cleaning compositions, especially liquid laundry detergents and cleaning compositions, dental care compositions, hair dyeing compositions and decolorizing or bleaching compositions for industrial applications, which comprise the inventive capsules.

In the case of liquid, especially aqueous laundry detergents and cleaning compositions, which are enjoying increasing popularity owing to their positive product properties, such as better and more rapid solubility and also usability, the formulation or incorporation of bleach components is problematic for numerous reasons. For instance, bleaches used frequently lose their activity even in the course of storage, for example owing to decomposition or hydrolysis reactions and incompatibilities toward other constituents of the laundry detergent formulation, for example enzymes or surfactants.

This results in the disadvantageous consequences of a distinct loss in washing performance, especially bleaching capacity, so that especially bleachable stains can no longer be removed satisfactorily.

The bleach components used typically for solid laundry detergent formulations, for example perborates or percarbonates, are extremely moisture-sensitive, so that, in a liquid and especially aqueous laundry detergent and cleaning composition, a distinct decline in their bleaching action is frequently observed within a few days owing to the loss of active oxygen. Therefore, such active ingredients may frequently already have lost their bleaching action and thus be ineffective at the time of their use, especially in the wash liquor.

In contrast, peroxycarboxylic acids, especially imidoperoxycarboxylic acids, whose most important representative is phthalimidocaproic acid (PAP), are more efficient and less hydrolysis-sensitive and known in the prior art as bleaches for laundry detergents and cleaning compositions. However, their storage stability is far from sufficient to ensure long-term usability of the corresponding laundry detergent or cleaning composition without accompanying loss of activity. The use of peroxycarboxylic acids, especially imidoperoxycarboxylic acids, is particularly problematic in liquid laundry detergents and cleaning compositions.

Owing to the disadvantages which arise in relation to a change in the laundry detergent or cleaning composition formulation owing to the degradation of imidoperoxycarboxylic acids, especially PAP, attempts have been made in the prior art to effectively encapsulate the imidoperoxycarboxylic acids (e.g., PAP), so that the imidoperoxycarboxylic acids cannot come into direct contact with their environment, especially the remaining components of the laundry detergent or cleaning composition formulation, or contact of the imidoperoxycarboxylic acids with their environment is reduced.

(2) Description of Related Art, Including Information Disclosed Under 37 C.F.R. §§ 1.97 and 1.98.

For instance, waxes are frequently used in the prior art as a protective coating for sensitive laundry detergent additives, for example peroxycarboxylic acids. In this context, EP 0 510 761 B1, and U.S. Pat. No. 5,230,822 belonging to the same patent family, describe a general process for encapsulating laundry detergent additives of any type, for example enzymes, bleaches, including PAP, bleach precursors and bleach catalysts. The use described there of a wax whose melting point is between 40° C. and 50° C. leads to the active substances not being released in the wash liquor until temperatures above the melting point of the wax used, which is disadvantageous against the background of the development of high-performance laundry detergent and cleaning composition formulations and the saving of energy costs, since it should especially be possible to wash at about 30° C. Moreover, the use of a wax with a high melting point has the disadvantage that it causes residues on the laundry especially at low temperatures, since it is not fully emulsified at these temperatures.

Moreover, WO 93/045545 A1 describes active composition-containing capsules which are produced using a carrier phase and a block copolymer with the aid of a mini-emulsion process. The active ingredients listed there have to be dissolved in the oil phase, so that the capsule systems described there are restricted substantially to oil phase-soluble, especially hydrophobic active substances. Bleaches are not mentioned there. To produce the mini-emulsion, high-pressure homogenization is required.

Furthermore, attempts have been made in the prior art to develop other methods of stabilizing peroxycarboxylic acids, an emphasis having been placed on modifications of the liquid formulations into which the peroxycarboxylic acids can be incorporated.

For instance, EP 0 334 405 B1 describes an aqueous bleach composition which comprises a particulate and substantially water-insoluble organic peroxycarboxylic acid and additionally an alkanesulfonate and a fatty acid. The intention is to obtain a stable dispersion of the peroxycarboxylic acid and especially to prevent phase separation of the peroxycarboxylic acid from the aqueous medium. Protection in the sense of a chemical or physical stabilization of the peroxycarboxylic acid by the application of an encapsulation to the peroxycarboxylic acid is not envisaged.

In this context, EP 0 334 404 B1 also describes stabilization of the peroxycarboxylic acid to phase separation in an aqueous bleach composition by addition of a fatty acid. As in EP 0 334 405 B1, encapsulation of the peroxycarboxylic acid is not envisaged in EP 0 334 404 B1 either.

EP 0 337 516 A2 describes aqueous bleach compositions based on a water-insoluble organic peroxycarboxylic acid. The intention is to increase the stability of the peroxycarboxylic acid by the presence of alkanesulfonates and sodium sulfate in the liquid composition. Here too, there is no indication of encapsulation.

Moreover, WO 94/13776 describes aqueous bleach compositions based on peroxycarboxylic acids, in which stabilization of the peroxycarboxylic acid is generally provided by adjustments of the liquid compositions, i.e. the dispersant. Further stabilization of the peroxycarboxylic acid, in particular by encapsulation or coating structure which is applied to the peroxycarboxylic acid, is likewise not mentioned in this document.

EP 0 442 549 B1 describes the addition of hydrogen peroxide to a liquid bleach composition which comprises a particulate and substantially water-insoluble organic peroxycarboxylic acid, for example PAP. This is intended to increase the bleaching performance of the peroxycarboxylic acid, especially at relatively high temperatures. Here too, stabilization of the peroxycarboxylic acid takes place by means of adjustment or adaptation of the liquid matrix.

Finally, EP 0 435 379 A2 describes coating of imidoperoxycarboxylic acids with fatty acids, fatty alcohols or fatty esters and also stabilization of a dispersion comprising the imidoperoxycarboxylic acid by addition of an alkali metal salt of an alkylbenzenesulfonic acid or of an inorganic salt to this dispersion. The coating outlined there is a wax or wax-like substances which are not dissolved until higher temperatures and can lead to undesired residues in use.

### BRIEF SUMMARY OF THE INVENTION

Against this background, it is thus an object of the present invention to provide incorporation or encapsulation or coating of peroxycarboxylic acids, especially imidoperoxycarboxylic acids, such as phthalimidoperoxycaproic acid (PAP), with improved properties compared to the prior art, and also a corresponding production process.

It is a further object of the present invention to provide peroxycarboxylic acids, especially imidoperoxycarboxylic acids, such as phthalimidoperoxycaproic acid (PAP), in storage-stable form. A formulation form of peroxycarboxylic acids shall be developed which at least substantially prevents or reduces full or partial dissolution of the peroxycarboxylic acids in the state of concentrated dispersions, and whose solid or crystalline state preferably has a dissolution capacity for peroxycarboxylic acids even in the presence of surfactants or another environment, especially in laundry detergent or cleaning composition formulations. In this context, especially contact of the peroxycarboxylic acids with the environment shall be at least substantially prevented or at least reduced.

It is yet a further object of the present invention to provide capsules which are laden with peroxycarboxylic acids in solid form and lead to good stabilization of the peroxycarboxylic acids and thus to improved storage stability. In the context of the present invention, capsules shall be provided which dissolve rapidly during the washing operation and do not impair the release of the peroxycarboxylic acid, especially in the wash liquor. In particular, in the context of the present invention, capsules shall be provided which do not leave behind any residues during the washing operation, which shall be achieved by substantially full dissolution and/or solubilization or dispersion of the capsules. The process for producing these capsules shall equally be employable inexpensively, in a technically simple manner and on the industrial scale.

Applicants have now found that, surprisingly, organic peroxycarboxylic acids, such as imidoperoxycarboxylic acids (e.g., PAP), can be stabilized by encapsulation with an inorganic salt to a high degree, with simultaneously good usability.

In a first aspect, the present invention thus provides a process for producing capsules laden with at least one organic peroxycarboxylic acid, especially imidoperoxycarboxylic acid, in which a capsule coating based on at least one inorganic salt is applied to an organic peroxycarboxylic acid, especially imidoperoxycarboxylic acid, present in the form of solid particles, so as to result in capsules which comprise a capsule coating based on at least one inorganic salt and a capsule core based on at least one organic peroxycarboxylic acid, especially imidoperoxycarboxylic acid. In the context of the present invention, the peroxycarboxylic acid to be encapsulated is incorporated in a capsule coating or enclosed by it, so that the peroxycarboxylic acid forms the core of the inventive capsules; according to the invention, a capsule system with a core/shell structure is thus present. The inventive capsules may also each have a plurality of capsule cores; in particular, agglomerates of peroxycarboxylic acid particles can form in the course of the production. An agglomeration of a plurality of capsules is likewise possible. In this way, it is possible, so to speak, for a matrix to form, into which a plurality of capsule cores are embedded or incorporated.

The capsule coating is configured on the basis of at least one inorganic salt, the expression “on the basis of at least one inorganic salt” being understood in the context of the present invention to mean that, in addition to the inorganic salt, it is also possible for further materials or substances, especially as listed below, to be used to form the capsule coating. The same applies to the capsule core which is configured in accordance with the invention on the basis of at least one organic peroxycarboxylic acid and which may likewise have further substances, if desired or required for the application.

The process according to the invention for producing capsules laden with at least one organic peroxycarboxylic acid, especially imidoperoxycarboxylic acid (e.g., PAP), comprises especially the following process steps:
(a) providing at least one inorganic salt at least substantially inert toward the organic peroxycarboxylic acid, preferably in the form of a solution or dispersion comprising the inorganic salt; then
(b) applying the inorganic salt provided in process step (a), especially in the form of the solution or dispersion which comprises the inorganic salt and was provided in process step (a), to the organic peroxycarboxylic acid, especially imidoperoxycarboxylic acid, present in the form of solid particles, so that the peroxycarboxylic acid is at least substantially fully enclosed or coated by a capsule coating based on the inorganic salt; then
(c) optionally processing, especially drying and/or purifying and/or shaping and/or adjusting the particle size, of the resulting capsules.

### BRIEF DESCRIPTION OF THE SEVERAL VIEWS OF THE DRAWINGS

Not Applicable

### DETAILED DESCRIPTION OF THE INVENTION

According to the invention, the term “solution” or “dispersion” can be understood to mean a liquid medium, especially an aqueous medium, which comprises the inorganic salt preferably in dissociated form. In principle, it is also possible, though, for the inorganic salt to be present in dispersed form in the liquid medium in undissolved or only partly dissolved, for example crystalline form, for example when the solubility product of the corresponding inorganic salt in the medium has been exceeded.

In the process according to the invention, the substances used which are incorporated into the inventive capsules are organic peroxycarboxylic acids. These may be selected from organic mono- and diperoxycarboxylic acids. Examples thereof are especially dodecanediperoxy acid or preferably imidoperoxycarboxylic acids, more preferably 6-phthalimidoperoxycaproic acid (6-phthalimidoperoxyhexanoic acid, PAP). Advantageously, the peroxycarboxylic acid should have a melting point at atmospheric pressure, i.e. 101 325 Pa, above 25° C., especially above 30° C., preferably above 45° C., preferentially above 50° C., more preferably above 100° C. This ensures that the peroxycarboxylic acid used is present at least substantially in the form of solid particles, so that degradation of the peroxycarboxylic acids during the production of the capsules in the course of the process according to the invention is at least substantially prevented or reduced, and controlled release is achieved when the inventive capsule system is used.

In the context of the present invention, the particle size of the organic peroxycarboxylic acid used may be from 10 to 3000 μm, especially from 50 to 2500 μm, preferably from 100 to 1500 μm. In this context, the particle size of the organic peroxycarboxylic acid used should be ≦3000 μm, especially ≦2500 μm, preferably ≦2250 μm, preferentially ≦2000 μm, more preferably ≦1500 μm. According to the invention, the adjustment of the particle size of the solid peroxycarboxylic acid particles, and the size of the resulting inventive capsules which correlate to it, can preferably be carried out before the application of the capsule coating in process step (b), by processes known per se to those skilled in the art, for example by means of comminution or grinding, vibration and/or ultrasound input, sieving off and the like, so that it is possible in accordance with the invention to adjust the particle or capsule size in a controlled manner in accordance with its particular later use.

In general, the further components which are used in the inventive process for producing the capsules are selected such that they are at least substantially compatible in relation to the peroxycarboxylic acids to be encapsulated or to be coated, i.e. no undesired chemical reactions, especially degradation, oxidation or reduction reactions and/or hydrolysis reactions, between these components and the peroxycarboxylic acid, and no reactions of the peroxycarboxylic acid which are induced by the further components and lead to their degradation, especially loss of activity, should occur.

The inorganic salt used to produce the capsule coating should be a nonbasic salt, preferably a neutral or especially weakly acidic salt. The inorganic salt may be selected from the group of inorganic sulfate, nitrate and phosphate salts, preferably inorganic sulfate salts. For example, the inorganic salt may be selected from alkali metal or alkaline earth metal salts, preferably alkali metal salts. The inorganic salt should be a halide-free salt, especially a nonbasic, halide-free inorganic salt. In the context of the present invention, the inorganic salt is more preferably sodium sulfate. The inorganic salt is especially selected such that it at least substantially does not increase the pH of the solution or dispersion into which the inventive capsules can be transferred (for example a laundry detergent or cleaning composition formulation), or does not shift it in the direction of the alkaline range, since this can lower the stability of the peroxycarboxylic acid. In this context, the inorganic salt of the capsule coating should also not introduce any chloride ions into the solution or dispersion of the inventive capsules, since this likewise leads to a reduction in the stability of the peroxycarboxylic acid. Against this background, Applicants have found that especially sulfate salts, more preferably sodium sulfate, are suitable as a substance for the capsule coating of the inventive capsules and have a positive effect on the stability of the peroxycarboxylic acid. For further explanations, it is possible in this context to refer to the remarks which follow.

According to the invention, the content of inorganic salt in the solution or dispersion provided in process step (a) for the production of the capsule coating may be from 0.1 to 40% by weight, especially from 1 to 30% by weight, preferably form 5 to 25% by weight, based on the solution or dispersion. The content of inorganic salt in the solution or dispersion provided in process step (a) should preferably be more than 1% by weight, especially more than 5% by weight, preferably more than 10% by weight, based on the solution or dispersion. It is also possible for further substances to be added to the solution or dispersion and be incorporated into the capsule coating. It should also be ensured here that these substances neither influence the pH nor comprise halide ions, especially chloride ions, and are also inert toward the peroxycarboxylic acid to be encapsulated. For example, it is possible to add complexing agents or chelating agents, especially as described below, to the solution or dispersion of the inorganic salt.

According to the invention, the inorganic salt forming the capsule coating may be applied by spraying the solution or dispersion of the inorganic salt. In this connection, in process step (b), the solution or dispersion provided in process step (a) can be applied by spraying onto the peroxycarboxylic acid present in the form of solid particles, preferably in a fluidized bed unit or by means of spray drying (for example from a slurry of the peroxycarboxylic acid, especially PAP, and sodium sulfate). Alternatively, the capsule coating may also be applied in a coating pan, drum coater, mixer or Wurster coater.

The operating conditions should preferably be under atmospheric pressure and/or at a temperature of from 0 to 100° C., especially from 10 to 50° C., preferably from 20 to 50° C. According to the invention, it is also possible in principle to work at elevated pressures, if this is advantageous or required for process technology reasons. In general, the temperature should be selected such that temperature-dependent decomposition or dissolution of the organic peroxycarboxylic acid to be encapsulated or to be stabilized is at least substantially prevented.

In the process according to the invention, the capsule coating can be formed on the basis of physical or chemical interactions or reactions, for example precipitation, crystallization or crystal formation operations. The capsule coating can be formed, for example, by a crystallization of the dissolved or dissociated inorganic salt from the solution or dispersion, preferably by concentrating or evaporating the solvent or dispersant applied to the peroxycarboxylic acid, preferably water, but also by cooling or freezing-out. Without wishing to commit to a theory, these process steps under defined conditions can exceed the saturation concentration of the inorganic salt in the solution or dispersion, so that crystal formation or crystallization of the inorganic salt on the peroxycarboxylic acid results. Moreover, crystal formation can also be promoted or caused by precipitation or by salting-out operations, in which case, for example, a more readily soluble substance in relation to the inorganic salt or a further solvent for the inorganic salt with lower solubility, for example ethanol, can be added to the solution or dispersion.

In the context of the present invention, the crystal size of the inorganic salt applied to the peroxycarboxylic acid or of the resulting capsule coating can be adjusted within a wide range. Thus, the more slowly their growth process proceeds, the larger and more regular the crystals obtained (for example in the event of slow cooling or concentration or evaporation of the solution or dispersion). A capsule coating with finely crystalline structure can be obtained, for example, by rapidly cooling or rapidly evaporating the solution or dispersion.

In the process according to the invention, it is possible to apply to the organic peroxycarboxylic acid, preferably before application of the capsule coating, a substance which can enter into endothermic reactions with itself, for example water of crystallization elimination reactions or decomposition reactions, at a temperature below 80° C., especially below 70° C. According to the invention, this substance may also be combined with the peroxycarboxylic acid, especially mixed. Such a substance is, for example, boric acid. In the context of the present invention, this substance, preferably before application of the capsule coating, may be applied directly to the peroxycarboxylic acid, in which case, for example, the same process steps as for the formation of the capsule coating may be used. The substance added leads to an increase in the handling safety of the inventive capsules, since it can capture or compensate for any exothermicity which occurs. Exothermicity may be understood to mean a temperature increase occurring locally in the capsules, which can be caused by an exothermic decomposition of the peroxycarboxylic acid taking place or starting locally, but also a temperature increase occurring in a container or in the dispersion itself, for example in the course of storage. The added substance, for example boric acid, may also be introduced into the capsule coating comprising the inorganic salt. However, preference is given in accordance with the invention to application to the peroxycarboxylic acid, or combination or mixing with the peroxycarboxylic acid, since this leads to higher effectiveness with regard to the handling safety.

Moreover, it is possible in the process according to the invention to add at least one complexing agent to the capsule coating. This complexing agent may, for example, be selected from the group of quinoline and/or its salts, phosphates, alkali metal polyphosphonates, picolinic acid and dipicolinic acid, mono- or polyphosphonic acids, especially 1-hydroxyethylidene-1,1-diphosphonic acid (HEDP), ethylenediaminetetraacetic acid (EDTA), diethylenetriaminepenta(methylenephosphonic acid) (DTPMP), azacycloheptane diphosphonate (AHP) and/or nitrilotriacetic acid (NTA). In the process according to the invention, these complexing agents are used especially for complexing heavy metal ions which otherwise lead to accelerated degradation of peroxycarboxylic acids.

The drying which may be carried out in process step (c) may be effected by customary methods known per se to the person skilled in the art, for example by freeze-drying (lyophilization), evaporating the solvent, preferably at a temperature of from 40° C. to 60° C., ultrafiltration, dialysis or spray drying under gentle conditions. The shaping which may be carried out in process step (c) may be effected in accordance with the invention, for example, by rounding or the like.

The capsules which have been laden with at least one organic peroxycarboxylic acid, especially imidoperoxycarboxylic acid, and have been obtained by the process according to the invention may have a mean size (sphere diameter) of from 10 to 4000 μm, preferably from 50 to 2000 μm, preferably from 100 to 1000 μm. Optionally, should this be required or desired for application reasons, the capsules may be separated in accordance with their size (for example by classification), for example by means of sieving.

In the process according to the invention, the fraction of the capsule coating is generally ≧5% by weight, especially ≧10% by weight, preferably ≧20% by weight, based on the capsules. The content of organic peroxycarboxylic acid, especially imidoperoxycarboxylic acid, preferably PAP, is generally from 25 to 95% by weight, especially from 30 to 90% by weight, preferably from 40 to 85% by weight, more preferably from 50 to 80% by weight, based on the capsules. Depending on the application, an adjustment of the content of peroxycarboxylic acids should be undertaken, for example against the background of increasing the handling safety of the inventive capsules. For instance, for reasons of product safety, too high a content of peroxycarboxylic acid may be undesirable in some cases. For these cases, the content of peroxycarboxylic acid should, for example, be about 50% by weight based on the capsules.

The capsules produced by the process according to the invention have a controlled-release effect. A controlled-release effect is understood to mean especially a slight, preferably of between 1 and 15 minutes, delay in the dissolution of the capsules on use, for example in a wash liquor, or a delay in the release of the peroxycarboxylic acid from the inventive capsules.

In the process according to the invention, it is finally possible additionally to apply at least one additional capsule coating or coating layer to the capsules which have a capsule coating based on the at least one inorganic salt. The additional capsule coating may have at least one substance which may be selected from inorganic salts, especially sulfates or phosphates, inorganic oxides, organic polymers, for example cellulose ethers, polyvinyl alcohols (PVAI), polyvinylpyrrolidones (PVP). The additional capsule coating may also comprise a gel based on an oil phase solidified or gelled by adding at least one stabilizer, especially gel former. Preferably in accordance with the invention, the additional capsule coating may also be an especially multilayer polyelectrolyte capsule coating; for example, the multilayer polyelectrolyte capsule coating may comprise at least two layers which each have an oppositely charged polyelectrolyte or polyions oppositely charged in each case.

The application of an additional capsule coating or coating layer allows an additional stabilizing effect to be brought about in relation to the organic peroxycarboxylic acid to be stabilized. For example, this also allows an additional controlled release effect with regard to the peroxycarboxylic acids present in the inventive capsules to be achieved. The additional coating can lead to a suppression or reduction of the removal or dissolution of sulfate from the capsule coating, for example in an environment not fully saturated with the corresponding salt, and thus further stabilize the inventive capsule system. The application of the additional coating can be carried out in a manner known to those skilled in the art, for example by means of fluidized bed processes or by absorption of the additional coating material onto the particles from a solution, spraying of a solution or melt of the coating material onto the particles and subsequent evaporation of the solvent, preferably water, or by means of coating in a mixer, tank, etc. Also in relation to any further coating layers, it is possible to add further substances, for example complexing agents and the like, as long as it is desired or required in accordance with the invention.

The capsules obtained in process step (b) and/or (c) in the process according to the invention may be converted to a dispersion. In this case, the dispersion should comprise a dispersant, preferably water, and an inorganic salt which lowers the solubility of the inorganic salt forming the capsule coating in the dispersion. The salt dissolved or dispersed in the dispersion may advantageously correspond to the salt forming the capsule coating. The content of inorganic salt, more preferably sodium sulfate, in the dispersion should be selected such that degradation, especially removal or dissolution, of the capsule coating enclosing or coating the organic peroxycarboxylic acid in the state of the (concentrated) dispersion is at least substantially prevented or at least reduced. The formulation that “the inorganic salt of the dispersion corresponds to the inorganic salt of the capsule coating” is understood in accordance with the invention to mean that preferably identical salts, i.e. with the same cation and anion in each case, are used for the capsule coating and the dispersion of the capsules. In addition, it is, though, possible to use salts which have agreement in relation to at least one ionic constituent, i.e. are identical in relation to the particular cation or identical in relation to the particular anion. Moreover, the inorganic salt of the dispersion should generally be selected such that the concentrations of the corresponding anions or cations influence the solubility product of the inorganic salt of the capsule coating such that removal and/or dissolution of the capsule coating in the dispersion is at least substantially prevented or at least reduced. The type and concentration of the inorganic salt in the dispersion should thus be selected such that, in the dispersion, the saturation concentration of the inorganic salt of the capsule coating is substantially attained, or the concentration is preferably only slightly lower.

The content of inorganic salt, more preferably sodium sulfate, in the dispersion, especially in the dispersant, can be selected such that a dispersion essentially saturated with the inorganic salt is obtained at a temperature which is lower by 5° C., especially by 10° C., preferably by 15° C., than the storage temperature of the dispersion. In this context, the content of inorganic salt, more preferably sodium sulfate, should be selected such that essentially a dispersion or capsule dispersion saturated with the inorganic salt is obtained at from about 0° C. to 15° C., especially from 0° C. to 10° C., preferably from 0° C. to 5° C. The content of inorganic salt, more preferably sodium sulfate, in the dispersion, especially in the dispersant, may be from 5 to 30% by weight, especially from 10 to 30% by weight, preferably from 15 to 30% by weight, based on the dispersant. This is intended essentially to achieve at least substantial prevention or at least reduction of degradation, especially removal and/or dissolution, of the capsule coating which coats and/or encloses the organic peroxycarboxylic acid and is based on the at least one inorganic salt in the state of the (concentrated) dispersion.

According to the invention, the above-defined dispersion may be a laundry detergent and cleaning composition, especially a liquid laundry detergent and cleaning composition. The capsules obtained in process step (b) and/or (c) may, in accordance with the invention, be formulated together with further ingredients to give the laundry detergent or cleaning composition. The laundry detergent or cleaning composition should have at least substantially no halide ions, especially chloride ions, and the amount of halide ions, especially chloride ions, should be at most 500 ppm, preferably at most 100 ppm, more preferably at most 30 ppm. The pH should be at most 7 and especially in the range from 3.5 to 7, preferably from 4.0 to 6, more preferably from 4.5 to 6. Most preferably, the pH should be about 5. Moreover, the laundry detergent or cleaning composition may comprise at least one complexing agent; this may, for example, be selected from the group of quinoline and/or its salts, alkali metal polyphosphonates especially 1-hydroxyethylidene-1,1-diphosphonic acid (HEDP), ethylenediaminetetraacetic acid (EDTA), diethylenetriaminepenta (methylenephosphonic acid) (DTPMP), azacycloheptane diphosphonate (AHP), nitrilotriacetic acid (NTA), citrate and/or short-chain dicarboxylic acids. These complexing agents are used in the process according to the invention especially for complexing heavy metal ions. Moreover, the laundry detergent or cleaning composition may optionally have at least one water-miscible solvent with a low dissolution capacity for the organic peroxycarboxylic acid, especially imidoperoxycarboxylic acid (for example in amounts of preferably more than 20% by weight, more preferably more than 30% by weight, based on the laundry detergent or cleaning composition), or else the water-miscible solvent is the dispersant of the dispersion. For example, the solvent may be glycerol. In addition, at least one enzyme, such as at least one catalase and/or at least one peroxidase, preferably at least one catalase, and/or at least one antioxidant may be added to the laundry detergent or cleaning composition. For further details in relation to the laundry detergent or cleaning composition, reference may be made to remarks which follow.

The process according to the invention serves equally as a process for stabilizing peroxycarboxylic acids, especially imidoperoxycarboxylic acids, preferably PAP, and as a process for increasing the storability of peroxycarboxylic acids, especially imidoperoxycarboxylic acids, preferably PAP.

In a typical embodiment, the process according to the invention may be carried out as follows: to encapsulate or to protect the peroxycarboxylic acid, especially imidoperoxycarboxylic acid (e.g. PAP), which is present in the form of solid particles, especially in crystalline form, a capsule coating of a nonalkaline, inorganic salt is applied, so that the peroxycarboxylic acid can be stabilized very efficiently in a surfactant- and water-containing liquid matrix. To this end, preference is given to using sodium sulfate; the fraction of the capsule coating is more than 5% by weight, preferably more than 10% by weight, more preferably more than 20% by weight, based on the capsules. Since a soluble salt is removed spontaneously in a conventional water-based matrix, it is advantageous likewise to add a large amount of preferably the same salt, here a high concentration of sulfate, to the liquid matrix. The concentration in the liquid matrix should be more than 5% by weight, preferably more than 10% by weight, based on the entire system. In this context, Applicants have been able to show that full saturation with sulfate at room temperature is not necessarily required to obtain sufficient stability or storability of the capsule coating or of the inventive capsules.

Moreover, a further substance may be applied to the peroxycarboxylic acid. It is also possible, before the application of the capsule coating, to mix the peroxycarboxylic acid with a further component which can increase the handling safety of the capsules by an endothermic reaction which occurs at elevated temperature. An example of a suitable substance of this type is boric acid. Moreover, it is possible to admix a complexing agent to the capsule coating. Suitable complexing agents are especially those which are effective at a slightly acidic pH (from 3 to 6, preferably from 3.5 to 5.5). For example, phosphonates are suitable for this purpose, for example HDEP and DTPMP. It is also possible, in order to make the sulfate capsule coating in the liquid matrix even more stable, to apply a further capsule coating (coating). Suitable further capsule coatings are, for example, those which comprise polyelectrolyte layers with alternating charge and paraffin gel. These lead to the removal of the sulfate being suppressed further or at least delayed in an environment which is not yet entirely saturated.

In a second aspect of the present invention, the invention further provides the capsules which are laden with at least one organic peroxycarboxylic acid, especially imidoperoxycarboxylic acid (e.g. PAP) and are producible by the process according to the invention. These comprise at least one organic peroxycarboxylic acid, especially imidoperoxycarboxylic acid, preferably PAP, which has at least substantially been enclosed or coated with a capsule coating based on an inorganic salt, the capsules comprising a capsule coating based on at least one inorganic salt and a capsule core based on at least one organic peroxycarboxylic acid, especially imidoperoxycarboxylic acid.

If required or desired for the application, further additives or assistants may be added to the core material (=peroxycarboxylic acid) and/or to the capsule coating, for example stabilizers, modifiers, inorganic salts, dyes, complexing agents, etc. In this regard, reference may be made to above remarks.

For further details of the inventive capsules, reference may be made to above remarks on the process according to the invention which apply correspondingly in this context.

In the case of the inventive capsules, degradation, especially removal or dissolution, of the capsule coating when the capsules are employed (i.e. when the dispersion is diluted) is effected on the basis of physical or chemical interactions or reactions, for example solubilization or dissociation operations. In the context of the present invention, the encapsulated peroxycarboxylic acids, especially imidoperoxycarboxylic acid, for example PAP, may be released from the inventive capsules on dilution (for example in a wash liquor). In this case, the release may be effected especially by a degradation, for example by removal or dissolution or solubilization of the capsule coating with dilution (for example in the wash liquor). These processes may especially be caused by a dilution of the inorganic salt dissolved in the dispersion or in the liquid laundry detergent or cleaning composition. The dilution of the inorganic salt in the dispersion is preferably such that it goes below the solubility product of the inorganic salt forming the capsule coating in the dispersion or in the wash liquor such that degradation of the capsule coating, especially by removal or dissolution, can proceed. The release of the peroxycarboxylic acid can also be caused or promoted by further processes, for example osmotic processes and/or diffusion processes. For example, water molecules can diffuse along the concentration gradient through the capsule coating into the core region of the capsule system and lead there to partial or full dissolution of the peroxycarboxylic acid at a corresponding pH of the wash liquor, especially at a pH of ≧7. This allows the capsule coating to be burst open with accompanying release of the peroxycarboxylic acid in the wash liquor. Mechanical influences can also contribute to destruction of the capsule coating, as will be explained below. In particular, a combination of the individual aforementioned processes is also possible in relation to the release of the peroxycarboxylic acid from the inventive capsule system.

The inventive capsule system has numerous possible uses. For instance, the inventive capsules, in a further aspect of the present invention, may be used in laundry detergents and cleaning compositions, especially liquid laundry detergents or cleaning compositions, dental care compositions, hair dyeing compositions and for decolorizing or bleaching compositions for industrial applications.

In this context, the inventive capsules may also be used as a delivery system or controlled-release system for the controlled release of peroxycarboxylic acids, in which case the release of the peroxycarboxylic acid can be controlled especially by the composition and the thickness of the capsule coating. Composition is understood here in accordance with the invention especially to mean the type and/or amount of the appropriate inorganic salt in the capsule coating. A further possible modification is the application of at least one additional capsule coating (coating) to the inventive capsules; such a capsule system may also be used especially as a delivery system in which the peroxycarboxylic acids are delivered over a long period by prolonged or retarded release (sustained release effect).

In a further aspect of the present invention, the present invention further provides laundry detergents and cleaning compositions, especially liquid laundry detergents and cleaning compositions, dental care compositions, haircare compositions, and dye and bleach compositions, especially for industrial applications, which comprise the inventive capsules laden with at least one organic peroxycarboxylic acid, especially imidoperoxycarboxylic acid. The inventive laundry detergents and cleaning compositions which comprise the inventive capsule system can be used both in the domestic and in the industrial sector. In particular, the inventive laundry detergents and cleaning compositions are liquid laundry detergents and cleaning compositions which comprise the inventive capsules.

The inventive laundry detergents and cleaning compositions may be used for cleaning hard surfaces and/or soft, especially textile surfaces. The inventive laundry detergents and cleaning compositions may be used especially as dishwasher detergents, all-purpose cleaners, bath cleaners, floor cleaners, car cleaners, glass cleaners, furniture care compositions or cleaners, façade cleaners, laundry detergents or the like, more preferably as laundry detergents. Moreover, the inventive laundry detergents and cleaning compositions are preferably suitable for cleaning fibers, textiles, carpets and the like.

In addition to the inventive capsule system, the inventive laundry detergents and cleaning compositions comprise ingredients and constituents customary per se (surfactants, fragrances, dyes, enzymes, enzyme stabilizers, fragrances or builders, pH modifiers, other bleaches, bleach activators, silver protectants, soil repellents, optical brighteners, graying inhibitors, disintegration assistants, thickeners, defoamers or foam inhibitors, complexing agents for heavy metals, soil repellents, dye transfer inhibitors, solvents, optical brighteners and/or further customary ingredients), it being necessary in the context of the present invention to ensure the compatibility of the individual ingredients or constituents both with one another and with regard to the inventive capsules and to the peroxycarboxylic acids encapsulated therein, which is realized by controlled selection of the ingredients or constituents and/or their particular quantitative ratios. In this way, undesired interactions of these ingredients or constituents with the inventive capsules or the peroxycarboxylic acids incorporated therein can be prevented. As will be illustrated in detail below, the controlled selection of certain ingredients or constituents and/or their quantitative ratios allows a stabilizing effect to be brought about in relation to the inventive capsule system or the peroxycarboxylic acids encapsulated therein.

An inventive laundry detergent or cleaning composition, especially liquid laundry detergent or cleaning composition, comprises, for example, the following ingredients:
(i) capsules laden with at least one organic peroxycarboxylic acid, especially imidoperoxycarboxylic acid, according to the present invention, preferably in amounts of from 0.1 to 30% by weight; and/or
(ii) surfactants, especially cationic and/or an anionic surfactants, preferably in amounts of from 0 to 30% by weight, and/or nonionic surfactants, preferably in amounts of from 0 to 30% by weight; and/or
(iii) optionally electrolytes, especially inorganic and/or organic salts, especially phosphate, citrate and/or sulfate, more preferably sodium sulfate, preferably in amounts of from 5 to 30% by weight; and/or
(iv) optionally complexing agents, especially selected from the group of quinoline and/or its salts, alkali metal polyphosphonates, picolinic acid and dipicolinic acid, mono- or polyphosphonic acids, especially 1-hydroxyethylidene-1,1-diphosphonic acid (HEDP), ethylenediaminetetraacetic acid (EDTA), diethylenetriaminepenta(methylenephosphonic acid) (DTPMP), azacycloheptane diphosphonate (AHP), nitrilotriacetic acid (NTA), citrate and/or short-chain dicarboxylic acids, preferably in amounts of from 0 to 10% by weight; and/or
(v) optionally enzymes such as proteases, amylases, cellulases and/or lipases, and/or enzyme stabilizers, preferably in amounts of from 0 to 10% by weight; and/or
(vi) optionally builders, especially fatty acids, preferably saturated and/or branched fatty acids, especially having a melting point below 30° C., and/or citric acid and/or citrate, preferably in amounts of from 0 to 15% by weight; and/or
(vii) optionally fragrances, preferably in amounts of from 0 to 5% by weight; and/or
(viii) optionally assistants such as defoamers, pH regulators, rheology modifiers (thickeners), solvents, dyes; and/or
(ix) optionally further customary ingredients such as brighteners, etc.; and/or
(x) water;
   all weight data being based on the laundry detergent or cleaning composition.

In the inventive laundry detergents or cleaning compositions, especially liquid laundry detergents or cleaning compositions, the content of inorganic salt, more preferably sodium sulfate, in the dispersion (of the liquid laundry detergent or cleaning composition) should be selected such that essentially a dispersion saturated with the inorganic salt is present at a temperature which is lower by 5° C., especially by 10° C., preferably by 15° C., than the storage temperature (about 20° C.) of the dispersion. In this context, the content of inorganic salt, more preferably sodium sulfate, should be selected such that essentially a dispersion saturated with the inorganic salt is obtained at from about 0° C. to 15° C., especially from 0° C. to 10° C., preferably from 0° C. to 5° C. The content of inorganic salt, more preferably sodium sulfate, in the dispersion, especially in the dispersant, may be from 5 to 30% by weight, especially from 10 to 30% by weight, preferably from 15 to 30% by weight, based on the dispersant. For further details on this subject, reference may be made to above remarks.

This is because Applicants have been able to show that the inventive capsules can be incorporated stably into a laundry detergent or cleaning composition which is not entirely saturated with the inorganic salt, more preferably sodium sulfate, at storage or room temperature, without the capsule coating being degraded or removed or dissolved. It is thus not necessary in accordance with the invention, especially against the background of saving raw materials and minimizing production costs, to incorporate the inventive capsules into a laundry detergent or cleaning composition formulation saturated with the salt corresponding to the capsule coating. Without wishing to commit to a specific theory, the stability of the inventive capsules in such a formulation is based on very slow kinetics of the degradation processes, especially solubilization and/or dissociation operations, of the inorganic salt forming the capsule coating in the state of the concentrated dispersion.

Moreover, the content of inorganic salt, more preferably sodium sulfate, in the laundry detergent or cleaning composition should be selected such that the surfactants are at least substantially inactivated in the laundry detergent or cleaning composition, especially by salting-out, i.e. inducing a phase separation in a low-surfactant continuous phase and a preferably lamellar, generally highly viscous, crystalline or liquid-crystalline surfactant-rich phase, preferably by incorporating at least one sulfate compound, more preferably sodium sulfate. In this case, especially dissolution of the organic peroxycarboxylic acid is at least substantially prevented or at least reduced in the laundry detergent or cleaning composition formulation. According to the invention, the term “continuous phase” is understood to mean the dispersant with the constituents or ingredients dissolved therein (for example salts, surfactants, etc.). Preferably in accordance with the invention, the dispersant is water.

In this context, Applicants have been able to show that organic peroxycarboxylic acids, especially PAP, are decomposed rapidly in the presence of active surfactants (i.e. surfactants present in free or micellar form in the laundry detergent or cleaning composition formulation), since the peroxycarboxylic acids are dissolved to an enhanced extent by the surfactants and are extremely unstable in this dissolved state. In this context, especially nonionic surfactants, for example based on alkyl polyglycol ethers, lead to accelerated decomposition of the peroxycarboxylic acids. The addition of sulfate at least partly inactivates the surfactants, which is done especially by salting-out, in the course of which the surfactants are transferred from the especially micellar, active form to a preferably lamellar, crystalline or liquid-crystalline form (crystal or liquid-crystal formation) which is dispersed in a virtually surfactant-free continuous phase. The dispersed liquid crystal itself, which can be removed, for example, by centrifugation, should have maximum viscosity. The content of free or active surfactants in the inventive laundry detergent and cleaning composition formulations or in the continuous phase of the inventive laundry detergent and cleaning composition formulations should be at most 1%.

The concentration of the inorganic salt, more preferably sodium sulfate, in the inventive laundry detergent or cleaning composition should be selected such that, when the laundry detergent or cleaning composition is used in the wash liquor, the capsule coating of the inventive capsules is degraded, for example removed or dissolved, which can be achieved, for example, by a dilution effect on introduction of the laundry detergent or cleaning composition into the wash liquor. The extent of this dilution effect should be such that, especially when sodium sulfate is used as the inorganic salt, the surfactants are present again in active form when the laundry detergent or cleaning composition is used in the wash liquor. In particular, the concentration should be selected such that, as mentioned above, less than 1% of dissolved surfactant is present in the continuous phase of the undiluted laundry detergent or cleaning composition and, on temperature reduction, especially on temperature reductions down to 0° C., no crystallization of the sulfate takes place.

Since especially nonionic surfactants can be problematic with regard to the stability of peroxycarboxylic acid, the inventive laundry detergents and cleaning compositions have an appropriately adjusted or optimized surfactant ratio. The content of alkyl polyglycol ethers should be at a minimum.

In the context of the present invention, the inventive laundry detergents and cleaning compositions, especially liquid laundry detergents and cleaning compositions, should have at least substantially no halide ions, especially no chloride ions. The amount of halide ions, especially chloride ions, is preferably at most 500 ppm, preferably at most 100 ppm, more preferably at most 30 ppm. This is because Applicants have found that, surprisingly, a high halide ion concentration, especially chloride ion concentration, as is customary, for example, in conventional laundry detergents and cleaning compositions owing to contaminations of some raw materials or ingredients, leads to enhanced degradation of peroxycarboxylic acids. Thus, a reduction in the halide ion concentration, especially the chloride ion concentration, can lead to reduced degradation of the peroxycarboxylic acid. A low chloride ion concentration can be achieved in accordance with the invention, for example, by the use of methylsulfate, phosphate, tosylate or cumenesulfonate compounds, or by the use of low-chloride raw materials or ingredients (for example use of substantially halide-free components, for example halide-free surfactants, halide-free phosphonates, etc.).

Moreover, the inventive laundry detergents and cleaning compositions should have a pH of at most 7, especially a pH of from 3.5 to 7, preferably from 4.0 to 6.5, more preferably from 4.5 to 6, most preferably of about 5. Bleaches based on peroxycarboxylic acids such as PAP can surprisingly be stabilized relatively effectively in an acidic environment, especially at a pH of ≦3.5, whereas relatively rapid decomposition of peroxycarboxylic acids such as PAP takes place at neutral or alkaline pH values. The pH can be lowered in the inventive laundry detergents and cleaning compositions, for example, by adding acids or acidic salts. Preference is given in accordance with the invention to bisulfates, bicarbonates and organic polycarboxylic acids which may be used, for example, simultaneously also as builder substances. In addition, the phosphonates used as complexing agents may be incorporated as phosphonic acids and the desired pH may subsequently be established by adding alkalis.

The inventive laundry detergents or cleaning compositions may comprise at least one fatty acid. Preference is given in accordance with the invention to saturated and/or branched fatty acids, especially having a melting point below 30° C. In the context of the present invention, it is possible, for example, to use Isocarb-16° from Sasol in the inventive laundry detergents or cleaning compositions.

The inventive laundry detergents or cleaning compositions have an optimized citric acid or citrate content. As Applicants have found, citric acid or citrate can lead to degradation of peroxycarboxylic acids, especially PAP. Nevertheless, it may be necessary in some cases to use citric acid or citrates in the laundry detergent or cleaning composition or in the dispersant for the inventive capsules (for example as builders and/or as complexing agents). However, the amounts used should not be too high and be adjusted in relation to the peroxycarboxylic acids, especially PAP.

In addition, the inventive laundry detergent or cleaning composition may comprise at least one complexing agent which may especially be selected from the group of quinoline and/or its salts, alkali metal polyphosphonates, picolinic acid and dipicolinic acid, mono- or polyphosphonic acids, especially 1-hydroxyethylidene-1,1-diphosphonic acid (HEDP), ethylenediaminetetraacetic acid (EDTA), diethylenetriaminepenta(methylenephosphonic acid) (DTPMP), azacycloheptane diphosphonate (AHP), nitrilotriacetic acid (NTA), citrate and/or short-chain dicarboxylic acids. Further examples of complexing agents, usable in accordance with the invention, for heavy metals are, for example, aminopolycarboxylic acids, aminohydroxypolycarboxylic acids, polyphosphonic acids and aminopolyphosphonic acids. These complexing agents are used in accordance with the invention in order to inactivate or to bind heavy metal ions which function especially as catalysts of oxidation processes and can thus lead to degradation of peroxycarboxylic acids such as PAP, and can be introduced into the inventive laundry detergent or cleaning composition, for example, via water pipes or metallic components of the production plants or via raw materials or ingredients.

Furthermore, the inventive laundry detergents and cleaning compositions may comprise at least one water-miscible solvent with a low dissolution capacity for the organic peroxycarboxylic acids, preferably glycerol.

Moreover, the inventive laundry detergents and cleaning compositions may comprise at least one catalase in order to effectively remove any hydrogen peroxide formed by reaction of the peroxycarboxylic acid with water from the continuous phase of the product, especially of the laundry detergent or cleaning composition, so that especially the enzymes which may be present there are protected effectively from oxidation processes which may in some cases lead to a loss of activity of the enzymes. For this purpose, it is equally possible to add at least one peroxidase and/or at least one antioxidant, if appropriate in addition to the at least one catalase, to the inventive laundry detergents or cleaning compositions. Antioxidants preferred in accordance with the invention are, for example, ascorbic acid, tocopherol, gallic acid or derivatives thereof.

Moreover, the inventive laundry detergent or cleaning composition formulation should be configured such that they especially substantially do not partly or fully dissolve the inventive capsules. In general, the components which are used in the inventive laundry detergent or cleaning composition should be selected such that they are at least substantially compatible in relation to the inventive capsules, i.e., especially in the laundry detergent or cleaning composition itself, especially in the period before its use (storage time), no undesired chemical reactions, especially degradation, oxidation or reduction reactions and/or hydrolysis reactions, should occur between these components and the capsules, which lead to premature degradation and to a loss of activity of the peroxycarboxylic acids.

In order to achieve sufficient bleaching performance in the wash liquor, the peroxycarboxylic acid should be released sufficiently rapidly from the inventive capsules. The peroxycarboxylic acid is released when the laundry detergent or cleaning composition is used especially by physical or by physicochemical or chemical processes, for example by degradation, especially removal or dissolution, of the capsule coating in the wash liquor, and by osmotic processes or diffusion processes. The encapsulated peroxycarboxylic acids, especially imidoperoxycarboxylic acid, for example PAP, can be released from the inventive capsules, especially in a wash liquor, by a degradation, for example by partial or full dissolution or solubilization, of the capsule coating. These processes may especially be caused by a dilution effect. The dilution of the inorganic salt in the dispersion or in the wash liquor is preferably such that it goes below the solubility product of the inorganic salt forming the capsule coating in the dispersion or in the wash liquor, so that the capsule coating can be degraded, especially removed or dissolved.

The release of the peroxycarboxylic acid can also be caused or promoted by further processes. For instance, dilution of the inorganic salt, more preferably sodium sulfate, in the dispersion or wash liquor leads simultaneously to conversion of the surfactants from their inactive form (as are present, for example, by virtue of salting-out, for example in the form of liquid crystals in the undiluted laundry detergent or cleaning composition formulation) to the active, dissolved or micellar form, so that the surfactants activated in this way can partly and/or fully dissolve the peroxycarboxylic acid or can promote the solubilization of the capsule coating. In the case of dilution in the wash liquor, a distinct pH jump of the laundry detergent and cleaning composition, which is generally adjusted to an acidic pH, occurs simultaneously, so that this also results in a distinct increase in the solubility of the peroxycarboxylic acid.

Furthermore, diffusion processes can occur (for example diffusion of water molecules along the concentration gradient through the capsule coating into the core region of the capsule system, so that the peroxycarboxylic acid can be partly or fully dissolved there at an appropriate pH of the wash liquor, especially at a pH of ≧7). Provided that the capsule coating has not been fully degraded, this allows a high osmotic pressure to be generated within the capsules, which can lead, so to speak, to the capsule coating bursting open with accompanying release of the peroxycarboxylic acid in the wash liquor. Finally, mechanical processes also play a role, for example mechanical destruction of the capsules by the laundry items present in the wash liquor or by contact with the laundry drum. As explained above, the particular structure and the construction of the inventive capsules results in a controlled or delayed release of the peroxycarboxylic acid. In particular, a combination of the individual processes mentioned is also possible in relation to the release of the peroxycarboxylic acid from the inventive capsules.

The present invention exhibits a series of advantages over the prior art:

In the process according to the invention, the capsule coating is formed on the basis of physicochemical or physical interactions, so that no polymerization steps, especially free-radical polymerization steps, are needed for the formation of the capsule structure, as is the case in some prior art processes. Such polymerizations frequently lead to the decomposition of the active substance, especially of the sensitive peroxycarboxylic acid. The present invention thus provides an encapsulation process directed to the chemically sensitive peroxycarboxylic acids.

In addition, the process according to the invention has the advantage that it provides capsules laden with peroxycarboxylic acids, especially imidoperoxycarboxylic acids, which can be varied widely or tailored in relation to their size and their active substance content, so that individual adjustment to the particular requirements, especially in relation to the laundry detergents and cleaning compositions, is possible.

In this context, it is especially advantageous that the ratio of the capsule coating based on an inorganic salt can be adjusted in relation to the content of inorganic peroxycarboxylic acid, so that tailoring of the capsules in relation to the sensitivity of the peroxycarboxylic acids to be encapsulated can be achieved. The controlled adjustability of the capsule size can enable effective dosage of the active substance. In addition, it is possible to realize capsules with a high active substance content, so that only a small amount of starting substance has to be used for the capsule coatings.

In contrast to encapsulation systems which are based, for example, on waxes, the inventive capsules do not comprise any troublesome capsule coatings which lead to undesired residues on the laundry in the course of the washing process. The capsule coating consisting of the inorganic salt is simply dissolved in the wash liquor and virtually fully removed by rinsing processes.

The use of the inorganic salt, more preferably sodium sulfate, in the laundry detergent or cleaning formulation enables stabilization of the peroxycarboxylic acid firstly by inactivation of the surfactants and secondly by substantial prevention of the degradation of the capsule coating, so that the inorganic salt used fulfills a double function in this regard. The use of further substances, for example for inactivating surfactants, can therefore be dispensed with.

The inventive production process and the capsules produced in this way ensure that the inventive capsules can firstly be applied from aqueous solutions or dispersions and the capsules secondly cannot be partly or fully dissolved in an aqueous liquid formulation, for example a liquid laundry detergent or cleaning composition. The process according to the invention for producing these capsules is simple and less cost-intensive owing to the small number of process steps and also the inexpensive coating substances, and therefore of great interest especially for industrial production.

Moreover, selective modification of the capsule core or of the capsule coating, for example by addition of complexing agents for heavy metal ions, can achieve a further improvement in the protection of the peroxycarboxylic acid and an associated further increase in its storage stability. The application of further capsule coatings can further increase the stability, especially storage stability, of the peroxycarboxylic acid, so that there is outstanding adaptability of the inventive capsule system with regard to the particular use.

In particular, the inventive capsules are suitable for incorporation or use in systems comprising surfactants, for example surfactive (surfactant-containing) dispersions for liquid laundry detergents and cleaning compositions. This is a particular advantage since the unencapsulated and unprotected peroxycarboxylic acids, especially PAP, are not stable in the presence of surfactants and are decomposed rapidly, so that their use in surfactant-containing liquid, especially aqueous media, has not been possible to date or at best has been possible to a very restricted extent. The stabilizing effect of the capsules, which is associated additionally with a desired controlled release of the encapsulated peroxycarboxylic acid, can be enhanced in a synergistic manner by adjusting the medium in which the inventive capsules are present such that it affords additional stabilization in relation to the peroxycarboxylic acids, especially by inactivation of the surfactants, optimization or lowering of the pH, reduction of the halide content, use of a solvent with low dissolution capacity in relation to peroxycarboxylic acids and the like.

The inventive capsules can be incorporated stably especially into liquid laundry detergents and cleaning compositions. Additional prevention or reduction in capsule sedimentation can be achieved, for example, by suitable thickener systems known per se to those skilled in the art. The inventive capsules have high storage stability there and can release the peroxycarboxylic acid effectively even after prolonged periods.

Owing to their above-detailed synergistic modifications adjusted to one another, i.e. adjustment of the formulation, especially low halide ion content, optimization of the pH, addition of complexing agents, inactivation of the surfactants, specific solvents and enzymes such as catalases or peroxidases, addition of antioxidants, the inventive laundry detergents and cleaning composition formulations have considerable advantages over the prior art, since the degradation of the sensitive bleaches based on peroxycarboxylic acid is distinctly reduced in conjunction with the inventive capsules.

Further embodiments, modifications and variations, and also advantages of the present invention are directly recognizable and realizable by the person skilled in the art on reading the description without leaving the scope of the present invention.

The present invention is illustrated with reference to the working examples which follow, which do not, however, in any way restrict the invention:

### WORKING EXAMPLES

### Example 1

### Production of Inventive Encapsulated or Coated Bleach Capsules with a Sulfate Capsule Coating

800 g of Eureco® W (from Solvay) were sprayed in a laboratory fluidized bed unit (Aeromatic®) with 800 g of a 20% sodium sulfate solution to which 1% Sequion® 10H60 had been added. The resulting product was sieved off to <2.0 mm.

With the aid of an iodometric titration, the active substance content (pure PAP) was determined. A value of 70.5% was obtained.

### Example 2

### Stability Test

The coated bleach compound produced in example 1 was incorporated into the following liquid formulation (the percentages are active substance data):

| | |
|---|---|
| Dehydol ® LT7 (from Cognis) | 4.0% |
| LAS (Maranil ® A 55) (from Cognis) | 22.5% |
| Na₂SO4 | 12.5% |
| Sequion ® 10H60 (from Polygon Chemie AG) | 1.0% |
| Xanthan Gum (Jungbunzlauer) | 0.4% |
| Inventive capsules | 4.3% |
| Water | ad 100.0% |

The pH was adjusted to 5.0 with sodium hydroxide solution.

### Comparative Example

3.5% Eureco® W was incorporated untreated. The pH was likewise 5.0.

An iodometric titration was used to determine the active oxygen retentions (100% at start of storage) after different storage times at 40° C.

Results:

| | Inventive | Comparative example |
|---|---|---|
| 1 week | 99% | 75% |
| 2 weeks | 95% | 65% |

It can be seen that the stability of the PAP is distinctly increased in the inventive capsules.

### Example 3

Recipe for a further liquid formulation in which the inventive encapsulated or coated bleach capsules can be incorporated with a sulfate capsule coating:

| | |
|---|---|
| LAS (Maranil ® A 55) | 18.5% |
| Dehydol ® LT 7 (from Cognis) | 8% |
| Sodium sulfate | 11% |
| Xanthan gum | 0.4% |
| Sequion ® 10 H 60 (from Polygon Chemie AG) | 1% |
| Silicone defoamer | 0.2% |
| Capsule system from example 1 | 3% |
| Water | ad 100% (I) |

1. A process for producing capsules laden with at least one organic peroxycarboxylic acid which comprises an imidoperoxycarboxylic acid, comprising the step of applying a capsule coating based on at least one inorganic salt to the at least one organic peroxycarboxylic acid comprising imidoperoxycarboxylic acid present in the form of solid particles, so as to result in capsules which comprise a capsule coating based on at least one inorganic salt and a capsule core based on at least one organic percarboxylic acid comprising imidoperoxycarboxylic acid.

2. A process for producing capsules laden with at least one imidoperoxycarboxylic acid, as claimed in claim 1, comprising the following process steps:
(a) providing at least one inorganic salt at least substantially inert toward the imidoperoxycarboxylic acid, in the form of a solution or dispersion comprising the inorganic salt; then
(b) applying the inorganic salt provided in process step (a) to the imidoperoxycarboxylic acid present in the form of solid particles, so that the imidoperoxycarboxylic acid is at least substantially fully enclosed or coated by a capsule coating based on the inorganic salt; then
(c) optionally processing the resulting capsules.

3. The process as claimed in claim 1 characterized in that the imidoperoxycarboxylic acid is 6-phthalimidoperoxycaproic acid and/or has a melting point at atmospheric pressure above 100° C.

4. The process as claimed in claim 1, characterized in that the particle size of the organic peroxycarboxylic acid used is from 10 to 3000 μm.

5. The process as claimed in claim 1, characterized in that the inorganic salt is a nonbasic salt, and/or that the inorganic salt is selected from the group consisting of inorganic sulfate, nitrate and phosphate salts, and/or that the inorganic salt is a nonbasic, halide-free inorganic salt.

6. The process as claimed in claim 2, characterized in that the content of inorganic salt in the solution or dispersion provided in process step (a) is from 0.1 to 40% by weight, based on the solution or dispersion.

7. The process as claimed in claim 2, characterized in that, in process step (b), the solution or dispersion provided in process step (a) is applied by spraying onto the peroxycarboxylic acid present in the form of solid particles, in a fluidized bed unit, or by means of spray drying, operating under atmospheric pressure and/or at a temperature of from 0 to 100° C.

8. The process as claimed in claim 1, characterized in that the capsule coating is formed on the basis of physical and/or chemical interactions or reactions, including precipitation and/or crystallization and/or crystal formation operations.

9. The process as claimed in claim 1, characterized in that, before application of the capsule coating, a substance which can enter into endothermic reactions at a temperature below 80° C., is applied to the organic peroxycarboxylic acid and/or combined with the peroxycarboxylic acid.

10. The process as claimed in claim 1, characterized in that at least one complexing agent is selected from the group consisting of quinoline and/or its salts, phosphates, alkali metal polyphosphonates, picolinic acid and dipicolinic acid, mono- or polyphosphonic acids, 1-hydroxyethylidene-1,1-diphosphonic acid (HEDP), ethylenediaminetetraacetic acid (EDTA), diethylenetriaminepenta(methylenephosphonic acid) (DTPMP), azacycloheptane diphosphonate (AHP) and/or nitrilotriacetic acid (NTA), is added to the capsule coating for complexing heavy metal ions.

11. The process as claimed in claim 1, characterized in that the drying which may be carried out in process step (c) is effected by freeze-drying (lyophilization), evaporating the solvent, ultrafiltration, dialysis or spray-drying under gentle conditions, and/or that the shaping which may be carried out in process step (c) is effected by rounding.

12. The process as claimed in claim 1, characterized in that the capsules laden with the imidoperoxycarboxylic acid have a mean size (sphere diameter) of from 10 to 4000 μm.

13. The process as claimed in claim 1, characterized in that the fraction of the capsule coating is ≧5% by weight, based on the capsules, and/or that the content of imidoperoxycarboxylic acid is from 25 to 95% by weight, based on the capsules.

14. The process as claimed in claim 1, characterized in that at least one additional capsule coating is applied to the capsules obtained in process step (c), which have a capsule coating based on the at least one inorganic salt, wherein the additional capsule coating comprises at least one substance which is selected from inorganic salts of sulfates and/or phosphates, inorganic oxides, organic polymers, cellulose ethers, polyvinyl alcohols (PVAI), polyvinylpyrrolidones (PVP), and/or at least one gel and/or a multilayer polyelectrolyte capsule coating.

15. The process as claimed in claim 1, characterized in that the capsules obtained in process step (b) and/or (c) are converted to a dispersion, comprising a dispersant and an inorganic salt, wherein said dispersion lowers the solubility of the inorganic salt forming the capsule coating in the dispersion, such that degradation of the capsule coating enclosing the organic peroxycarboxylic acid is reduced.

16. The process as claimed in claim 15, characterized in that the dispersion saturated with the inorganic salt is obtained at a temperature which is lower by 5° C., than the storage temperature of the dispersion, and/or that the content of inorganic salt is selected such that a dispersion saturated with the inorganic salt is obtained at from 0° C. to 5° C., and/or that the content of inorganic salt in the dispersion is from 5 to 30% by weight, based on the dispersant.

17. The process as claimed in claim 1, characterized in that the capsules obtained in process step (b) and/or (c) are formulated together with further ingredients to give a laundry detergent or cleaning composition, wherein the laundry detergent or cleaning composition
has an amount of halide ions of at most 500 ppm, and/or
has a pH of at most 7, and/or
comprises at least one complexing agent, selected from the group consisting of quinoline and/or its salts, alkali metal polyphosphonates, picolinic acid and dipicolinic acid, mono- or polyphosphonic acids, 1-hydroxyethylidene-1,1-diphosphonic acid (HEDP), ethylenediaminetetraacetic acid (EDTA), diethylenetriaminepenta (methylenephosphonic acid) (DTPMP), azacycloheptane diphonsphonate (AHP), nitrilotriacetic acid (NTA), citrate and/or short-chain dicarboxylic acids, for complexing heavy metal ions; and or
optionally comprises at least one water-miscible solvent with a low dissolution capacity for the imidoperoxycarboxylic acid and/or
optionally comprises at least one catalase.

18. The process as claimed in claim 1, wherein the peroxycarboxylic acid is 6-phthalimidoperoxycaproic acid.

19. A process for stabilizing and/or increasing the stability of imidoperoxycarboxylic acids, comprising the step of applying a capsule coating based on at least one inorganic salt to the imidoperoxycarboxylic acid present in the form of solid particles so as to result in capsules which comprise a capsule coating based on the at least one inorganic salt and a capsule core of the imidoperoxycarboxylic acid.

20. A capsule comprising at least one organic peroxycarboxylic acid in particulate form that is at least substantially encapsulated by a coating based on an inorganic salt.

21. The capsule as claimed in claim 20, comprising an imidoperoxycarboxylic acid, which has at least substantially been encapsulated and/or coated with a capsule coating based on an inorganic salt.

22. The capsule as claimed in claim 21, characterized in that the imidoperoxycarboxylic acid is 6-phthalimidoperoxycaproic acid and/or has a melting point at atmospheric pressure above 100° C.

23. The capsule as claimed in claim 20, characterized in that the inorganic salt is a nonbasic salt selected from the group consisting of inorganic sulfate, nitrate and phosphate salts, alkali metal or alkaline earth metal salts and/or that the inorganic salt is a halide-free salt.

24. The capsule as claimed in claim 20, characterized in that the capsule coating is formed on the basis of physical and/or chemical interactions or reactions.

25. The capsule as claimed in claim 20, characterized in that a substance which can enter into endothermic reactions at a temperature below 80° C., is applied to the organic peroxycarboxylic acid, and/or mixed with the peroxycarboxylic acid, and/or that the capsule coating comprises at least one complexing agent which is selected from the group consisting of quinoline and/or its salts, phosphates, alkali metal polyphosphonates, picolinic acid and dipicolinic acid, mono- or polyphosphonic acids, 1-hydroxyethylidene-1,1-diphosphonic acid (HEDP), ethylenediaminetetraacetic acid (EDTA), diethylene-triaminepenta (methylenephosphonic acid) (DTPMP), azacycloheptane diphosphonate (AHP) and nitrilotriacetic acid (NTA).

26. The capsule as claimed in claim 21, characterized in that the particle size of the imidoperoxycarboxylic acid is from 10 to 3000 μm.

27. The capsule as claimed in claim 21, characterized in that the capsule coating is ≧5% by weight, based on the capsules, and/or that the content of imidoperoxycarboxylic acid is from 25 to 95% by weight, based on the capsules.

28. The capsule as claimed in claim 20, characterized in that degradation of the capsule coating when the capsules are employed is effected on the basis of physical and/or chemical interactions or reactions.

29. The capsule as claimed in claim 20, characterized in that at least one supplementary capsule coating is applied to the previously applied capsule coating.

30. A dispersion comprising liquid laundry detergents and compositions and capsules as claimed in claim 20.

31. A process for cleaning laundry comprising the step of contacting the laundry with the dispersion of claim 30.

32. A composition comprising capsules as claimed in claim 20.

33. The laundry detergent or cleaning composition, as claimed in claim 32, characterized in that it comprises:
(i) capsules as claimed in claim 21, preferably in amounts of from 0.1 to 30% by weight; and/or
(ii) cationic and/or anionic surfactants, in amounts of from 0 to 30% by weight, and/or nonionic surfactants, in amounts of from 0 to 30% by weight; and/or
(iii) optionally electrolytes in amounts of from 5 to 30% by weight; and/or
(iv) optionally complexing agents selected from the group consisting of quinoline and/or its salts, alkali metal polyphosphonates, picolinic acid and dipicolinic acid, mono- or polyphosphonic acids, 1-hydroxethylidene-1,1-diphosphonic acid (HED)), ethylenediaminetetraacetic acid (EDTA), diethylenetriaminepenta (methylenephosphonic acid) (DTPMP), azacycloheptane diphosphonate (AH P), nitrilotriacetic acid (NTA), citrate and/or short-chain dicarboxylic aids, in amounts of form 0 to 10% by weight; and/or
(v) optionally enzymes and/or enzyme stabilizers in amounts of from 0 to 10% by weight; and/or
(vi) optionally builders in amounts of from 0 to 15% by weight; and/or
(vii) optionally fragrances in amounts of from 0 to 5% by weight; and/or
(viii) optionally assistants such as defoamers, pH regulators, rheology modifiers (thickeners), solvents, dyes; and/or
(ix) optionally brighteners; and/or
(x) water;
all weight data being based on the laundry detergent or cleaning composition.

34. The laundry detergent or cleaning composition as claimed in claim 32, wherein the laundry detergent or cleaning composition
has an amount of halide ions of at most 500 ppm, and/or
has a pH of at most 7, and/or
comprises at least one complexing agent, selected from the group consisting of quinoline and/or its salts, alkali metal polyphosphonates, picolinic acid and dipicolinic acid, mono- or polyphosphonic acids, 1-hydroxyethylidene-1,1-diphosphonic acid (HEDP), ethylenediaminetetraacetic acid (EDTA), diethylenetriaminepenta (methylenephosphonic acid) (DTPMP), azacycloheptane diphosphonate (AH), nitrilotriacetic acid (NTA), citrate and/or short-chain dicarboxylic acids, for complexing heavy metal ions; and/or
optionally comprises at least one water-miscible solvent with a low dissolution capacity for the imidoperoxycarboxylic acid; and/or
optionally comprises at least one catalase;
so that degradation of the imidoperoxycarboxylic acid in the laundry detergent or cleaning composition is reduced.
